(19) United States
(12) Patent Application Publication
(10) Pub. No.: US 2007/0228769 A1
(43) Pub. Date: Oct. 4, 2007

(54) Side impact protection device packaged between inner and outer panels

(76) Inventors: Bhushan W. Dandekar, Rochester Hills, MI (US); Clare V. Gutowski, St. Clair Shores, MI (US); Dmitriy V. Mazur, West Bloomfield, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/391,096

(22) Filed: Mar. 28, 2006

(51) Int. Cl. B60J 5/00

(52) U.S. Cl. 296/146.6; 296/187.12

(57) ABSTRACT

A side impact protection device for a vehicle packaged between inner and outer panels such as door panels in the door includes a load-bearing member rigidly attached with respect to an inner surface of a side outer panel and extending inward towards a side inner panel. The load-bearing member is configured to deflect a side impact load away from a portion of the side inner panel located between the load-bearing member and a rearward edge of the side outer panel. In some embodiments, the load-bearing member permits compliant flexing of the door inner panel by partially forming a cavity into which the door inner panel may flex when the side impact load is deflected by the load-bearing member.

### TECHNICAL FIELD

The invention relates to a load-bearing member packaged between a side inner panel and a side outer panel of a vehicle.

### BACKGROUND OF THE INVENTION

It is desirable to protect a vehicle occupant from an impacting barrier during a side impact event. Reducing the peak accelerations encountered by the occupant improves occupant performance and compliance with government mandated testing which depends in part upon rib accelerations encountered by a crash dummy during a side impact event. Reduced rib acceleration may be achieved by using foam or another compliant material in the side structure of the vehicle, such as a door. Alternatively, a thorax air bag may be packaged between the panels. Regardless of the option used, welding or fastening any side impact counter measures to the door outer panel must be avoided as this could mar the visible appearance of the outer surface of the door outer panel.

### SUMMARY OF THE INVENTION

A side impact protection device is provided that overcomes the above-mentioned packaging constraints and limitations on the door outer panel while sufficiently deflecting a side impact load away from a portion of a side inner panel desired to be preserved (i.e., a portion that is laterally-aligned with the expected rib position of a vehicle occupant). Specifically, the side impact protection device includes a load-bearing member that is rigidly attached, directly or indirectly, to an inner surface of a side outer panel, such as a door outer panel or a quarter outer panel. The load-bearing member extends inward toward a side inner panel, such as a door inner panel or quarter inner panel. The load-bearing member is configured to deflect a side impact load away from a portion of the side inner panel that is located between the load-bearing member and a rearward edge of the side outer panel. Thus, this portion of the side inner panel, which is laterally-aligned with a vehicle occupant, is protected from the side impact load and, in some embodiments, is preserved as a compliant area for the occupant.

If the load-bearing member is packaged in a door, the load-bearing member may extend substantially vertically between two opposing edges of the door outer panel so that a cavity is formed that is bounded by the load-bearing member, one of the edges of the door outer panel and the two door panels. The cavity permits compliant outward flexing of the door inner panel into the cavity when deflection of the side impact load occurs. The compliant flexing is designed to reduce rib acceleration. If the door is on a vehicle that has spaced, generally vertical frame pillars, such as an A-pillar and a B-pillar partially defining a side of the vehicle, and the door panel substantially spans a space between the frame pillars, then the cavity is formed between the load-bearing member and the B-pillar (i.e., laterally-aligned with a vehicle seat).

In another embodiment, the side outer panel and the side inner panel are a quarter outer panel and a quarter inner panel, respectively. In a vehicle such as a coupe, the load-bearing member may be generally horizontally disposed at a forward portion of the quarter outer panel to deflect the side impact load away from a portion of the side inner panel rearward thereof which is laterally-aligned with a rear seat.

In either embodiment, the availability of structural adhesives that bond to metal, and preferably that bond metal to metal, allows the load-bearing member to be bonded directly to the door outer panel, without affecting the appearance of the outer surface of the door outer panel. Alternatively, the load-bearing member may be rigidly connected to a beltline reinforcement member that is connected to the door outer panel. In that instance, the load-bearing member could be welded to the beltline reinforcement member or otherwise fastened thereto. A portion of the load-bearing member extending downward below the beltline reinforcement member could be secured to the inner surface of the outer panel with a tacky adhesive to keep the load-bearing member from rattling. The load-bearing member could also integrally formed with the beltline reinforcement.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional view of a vehicle having a frame with spaced pillars and a vehicle door having a side impact protection device thereon;

FIG. 2 is a schematic illustration of load deflection and compliant flexing of a door inner panel of the vehicle door of FIG. 1 during a side impact event;

FIG. 3 is a fragmentary perspective view of an alternative embodiment of a side impact protection device having a load-bearing member rigidly connected with a beltline reinforcement member at an inner surface of a door outer panel;

FIG. 4 is another alternative embodiment of a side impact protection device with a load-bearing member integrally formed with a beltline reinforcement member at the inner surface of the door outer panel;

FIG. 5 is schematic cross-sectional view of yet another embodiment of a side impact protection device incorporated between rear quarter panels; and

FIG. 6 is a schematic perspective view of the side impact protection device of FIG. 5 connected to an inner surface of the quarter outer panel of FIG. 5.

### DESCRIPTION OF THE PREFERRED EMBODIMENTS

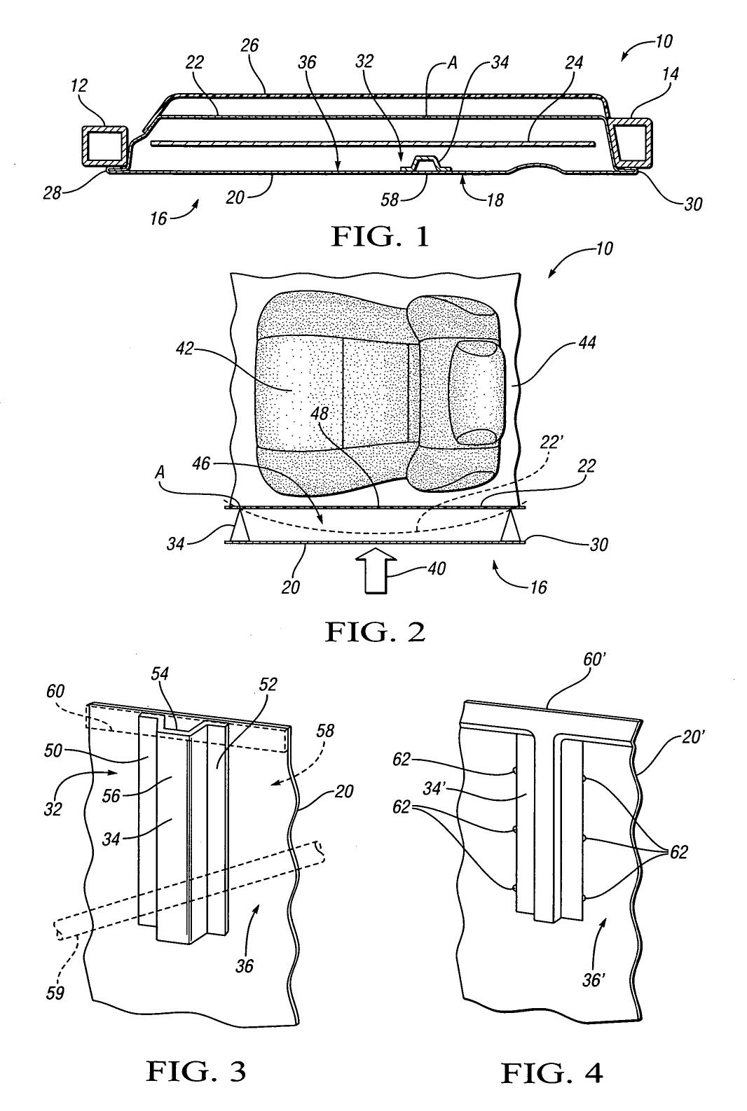

Referring to the drawings, wherein like reference numbers refer to like components, in FIGS. 1 and 2, a vehicle 10 is represented in part by spaced frame pillars 12 and 14 and a vehicle door 16 therebetween. Frame pillar 12, is commonly referred to as an A-pillar and frame pillar 14 is commonly referred to as a B-pillar. The frame pillars 12 and 14, as well as the door 16, partially form and define a side 18 of the vehicle 10.

The door 16 includes a door outer panel 20 (also referred to herein as a side outer panel) and a door inner panel 22 (also referred to herein as a side inner panel). A window 24 is packaged within the door 16. A trim panel 26 is connected inboard of the door inner panel 22. Latches (not shown) support the opposing ends 28, 30 of the door 16 at the frame pillars 12, 14 as is understood by those skilled in the art.

The door 16 includes a side impact protection device 32. The side impact protection device 32 includes a load-bearing member 34 that is rigidly secured to an inner surface 36 of the door outer panel 20. In the embodiment of FIG. 1, the load-bearing member 34 is substantially vertically disposed. There are various alternative methods of rigidly securing the load-bearing member 34 to the inner surface 36 of the door outer panel 20, as discussed herein. The load-bearing member 34 is generally laterally aligned with a representative point A on the door inner panel 22. An impact beam running lengthwise in the door may be packaged below the load-bearing member 34.

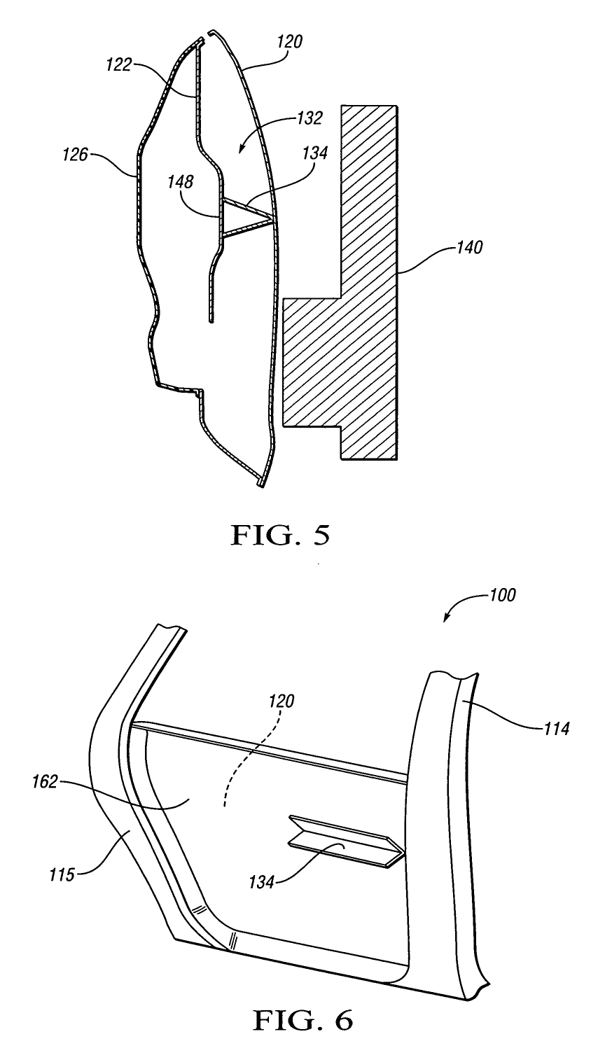

A “load-bearing member” as used herein may have a variety of shapes. For example, the load-bearing member may have a cylindrical, beam-like shape, may have a cross-sectional C shape, I shape, or U shape (see FIGS. 1, 3 and 4) or may have a cross-sectional V shape (see FIGS. 5 and 6). The load-bearing member is not limited to these shapes, however. Preferably, the load-bearing member is elongated and is attached to the door outer panel (or a quarter outer panel or beltline reinforcement member, as described below) along at least a portion of its length. The load-bearing member may be made from a variety of materials, such as steel, that are of a strength sufficient to permit the load deflection function of the load-bearing member as described herein.

Referring to FIG. 2, the vehicle 10 includes the door 16 shown schematically to indicate deflection during a side impact by an impacting load 40. The door 16 is adjacent a vehicle seat 42 secured to vehicle floor 44 of the vehicle 10. When the side impact load 40 impacts the door outer panel 20, the door outer panel 20 is moved generally inboard until the load-bearing member 34 contacts the door inner panel 22 which is expected to occur generally at point A. The end 30 of the door outer panel 20 forms another load deflection path due to its proximity to the pillar 14 to transfer impact energy to pillar 14. The load-bearing member 34 forms a load deflection path as indicated at 34 in FIG. 2 from the door outer panel 20 to the door inner panel 22 generally in the vicinity of point A. A cavity 46 is formed between the door outer and door inner panels 20, 22 and the load-bearing member 34 and the rearward end 30 of the door outer panel 20. A portion 48 of the door inner panel 22 between the load-bearing member 34 and rearward end 30 of the door outer panel 20 is laterally aligned with the cavity 46. The portion 48 is also laterally aligned with the seat 42. Thus the door inner panel 22 may flex outward into the cavity 46, providing a compliant surface during a side impact event. The flexed door inner panel is schematically represented as 22′ in FIG. 2. The trim panel 26 is not represented in FIG. 2 as its role in load deflection and energy absorption is minimal in comparison with the door inner and outer panels 22, 26.

Referring to FIG. 3, the load-bearing member 34 of the impact protection device 32 is shown rigidly connected to the inner surface 36 of the door outer panel 20. Load-bearing member 34 has side flanges 50, 52 with an extending portion 54 that includes a contact portion 56. The extending portion 54 extends inward toward the door inner panel 22 of FIG. 1 and the contact portion 56 contacts the door inner panel 22 at point A during the side impact event. The load-bearing member 34 is rigidly affixed to the inner surface 36 of the door outer panel 20 by structural adhesive placed between the flanges 50, 52 and the door outer panel 20. Numerous structural adhesives are commercially available that would be appropriate for rigidly connecting the load-bearing member 34 to the door outer panel 20 without affecting the outer surface 58 (shown in FIG. 1) of the door outer panel 20. For example, the following adhesives may be used: Betaseal® 66613, manufactured by Dow Automotive of Auburn Hills, Mich.; Terokal® 4555B, manufactured by Henkel Corporation of Madison Heights, Mich., and Versilok® 253/254, manufactured by Lord Corporation of Cary, N.C.

Referring to FIG. 3, in one embodiment, the load-bearing member 34 is secured to the inner surface 36 using structural adhesive alone. In another alternative embodiment, the load-bearing member 34 is welded, bolted or otherwise fastened to a beltline reinforcement member indicated in phantom as 60 in FIG. 3. Those skilled in the art understand that a beltline reinforcement member is a structural reinforcement of the portion of the door outer panel 20 at the beltline (the upper edge of the outer door panel 20) inward of the outer surface 58. The load-bearing member 34 may be bolted, welded or otherwise fastened to the beltline reinforcement 60 without affecting the appearance of the outer surface 58 of the outer door panel 20. Alternatively, the load-bearing member 34 may be welded to a door impact beam 59.

Referring to FIG. 4, another embodiment depicting an alternative way of rigidly connecting the load-bearing member, indicated as 34′ in FIG. 4, to the inner surface 36′ of door outer panel 20′ may be accomplished by forming the beltline reinforcement 60′ integrally with the load-bearing member 34′. Spacers 62, commonly referred to as “gumdrops”, are positioned at spaced intervals may be placed between the load-bearing member 34′ and the inner surface 36′ to prevent rattling of the load-bearing member 34′. Similar spacers 62 may be utilized in the embodiment shown in FIG. 3 if the load-bearing member 34 is rigidly connected only to the beltline reinforcement member 60.

Referring to FIGS. 5 and 6, another embodiment of a side outer panel 120 and a side inner panel 122 having a side impact protection device 132 including a load-bearing member 134 is depicted. A trim panel 126 is attached inboard of the side inner panel 122. As is apparent in FIG. 6, the side outer panel 120 is positioned between spaced frame pillars 114 and 115. Pillar 114 is the B-pillar and pillar 115 is the C-pillar. Thus, the side outer panel 120 and the side inner panel 122 may be referred to as a quarter outer panel and quarter inner panel, respectively, as are typically used on a coupe-type vehicle 100. In this embodiment, the load-bearing member 134 is disposed generally horizontally rearward of the B-pillar 114. Thus, energy of the impacting member 140 will be deflected through the load-bearing member 134 to the side inner panel 122 and away from a portion 148 of the side inner panel 122 that is rearward of the load-bearing member 134 and opposite portion 162 of the side outer panel 120 shown in FIG. 6. Preferably, a rear seat is laterally aligned with the portion 148. As with the load-bearing member 34 of FIGS. 1 through 3 and the load-bearing member 34′ of FIG. 4, the load-bearing member 134 may be adhered to the side outer panel 120 using a structural adhesive.

The side impact protection devices 32 and 132 described herein deflect impact energy away from protected portions of the vehicle panels to protect occupants adjacent those portions. The side impact protection devices 32 and 132 are easily packaged between the respective panels 20, 22 and 120, 122, avoiding the need for a specially molded foam insert or a thorax air bag between the respective outer and inner panels.

While the best modes for carrying out the invention have been described in detail, those familiar with the art to which this invention relates will recognize various alternative designs and embodiments for practicing the invention within the scope of the appended claims.

1. A side impact protection device for a vehicle comprising:
a load-bearing member rigidly attached with respect to an inner surface of a side outer panel and extending inward toward a side inner panel; wherein said load-bearing member is configured to deflect a side impact load away from a portion of said side inner panel located between said load-bearing member and a rearward edge of said side outer panel.

2. The side impact protection device of claim 1, wherein said side outer panel is a door outer panel and said side inner panel is a door inner panel, wherein said load-bearing member extends substantially vertically between two opposing edges of said door outer panel such that a cavity is formed bounded by said load-bearing member, one of said edges, and said door panels to permit compliant flexing of said door inner panel into said cavity when deflection of the side impact load occurs.

3. The side impact protection device of claim 1, wherein said load-bearing member is bonded directly to said inner surface of said side outer panel with a structural adhesive.

4. The side impact protection device of claim 1, wherein said load-bearing member is rigidly connected to a beltline reinforcement member connected to said side outer panel.

5. The side impact protection device of claim 1, wherein said load-bearing member is an integral portion of a beltline reinforcement member connected to said side outer panel.

6. The side impact protection device of claim 1, wherein said side outer panel is a quarter outer panel; wherein said side inner panel is a quarter inner panel and wherein said load-bearing member is generally substantially disposed.

7. A side impact protection device for a vehicle having spaced, generally vertical frame pillars partially defining a side thereof, the device comprising:
a load-bearing member rigidly attached with respect to an inner surface of a side outer panel and extending inward toward a side inner panel; wherein said side outer panel and said side inner panel substantially span a space between said frame pillars; and wherein said load-bearing member is configured to deflect a side impact load away from a portion of said side inner panel located between said load-bearing member and a rearward one of said vertical frame pillars.

8. The side impact protection device of claim 7, wherein said frame pillars include an A-pillar and a B-pillar; wherein said side outer panel is a door outer panel and said side inner panel is a door inner panel; and wherein said load-bearing member extends substantially vertically between two opposing edges of said door outer panel such that a cavity is formed bounded by said load-bearing member, one of said edges, and said door panels to permit compliant flexing of said door inner panel into said cavity when deflection of the side impact load occurs.

9. The side impact protection device of claim 7, wherein said load-bearing member is bonded directly to said inner surface of said door outer panel with a structural adhesive.

10. The side impact protection device of claim 7, wherein said load-bearing member is rigidly connected to a beltline reinforcement member connected to said door outer panel.

11. The side impact protection device of claim 7, wherein said load-bearing member is an integral portion of a beltline reinforcement member connected to said door outer panel.

12. A vehicle door comprising:
a load-bearing member rigidly attached with respect to an inner surface of a door outer panel and extending inward toward a door inner panel; wherein said load-bearing member is configured to deflect a side impact load away from a portion of said door inner panel located rearward of said load-bearing member and forward of a rearward edge of said side outer panel; and wherein said load-bearing member extends substantially vertically between two opposing edges of said door outer panel such that a cavity is formed bounded by said load-bearing member, one of said edges, and said door panels to permit compliant flexing of said door inner panel into said cavity when deflection of the side impact load occurs.

13. The vehicle door of claim 12, wherein said load-bearing member is bonded directly to said inner surface of said door outer panel with a structural adhesive.

14. The vehicle door of claim 12, wherein said load-bearing member is rigidly connected to a beltline reinforcement member connected to said door outer panel.

15. The vehicle door of claim 12, wherein said load-bearing member is an integral portion of a beltline reinforcement member connected to said door outer panel.
